(19) United States
(12) Patent Application Publication
(10) Pub. No.: US 2026/0322993 A1
(43) Pub. Date: Oct. 15, 2026

(54) HANDHELD BOX-TYPE STEREOSCOPIC DISPLAY DEVICE WITH INTEGRATED EMBEDDED SPACE

(71) Applicant: LIGHT MATRIX INC., Taipei City (TW)

(72) Inventor: Wei-Ting CHEN, Taipei City (TW)

(21) Appl. No.: 19/260,515

(22) Filed: Jul. 6, 2025

(30) Foreign Application Priority Data
Apr. 14, 2025 (TW) 114114032

(51) Int. Cl. H04N 13/398; G06F 3/041; G06F 3/044; H04N 13/128; H04N 13/305; H04N 13/31

(52) U.S. Cl. CPC H04N 13/398; G06F 3/04186; H04N 13/128; G06F 3/044; H04N 13/305; H04N 13/31

(57) ABSTRACT

A handheld box-type stereoscopic display device with integrated embedded space is provided. The handheld box-type stereoscopic display device includes an integrally formed embedded glass trough with rounded edges and corners, an outer surface of the embedded glass trough is opaque, the embedded glass trough is embedded and fixed in an outer shell, the front cover is embedded and fixed with a transparent touch panel, the front cover covers and is fixed in the outer shell to form a seal, and the transparent touch panel covers the embedded glass trough to form a sealed stereoscopic image displayer space for displaying the stereoscopic image, the transparent touch panel realizes touch tapping and sliding operation, thereby achieving the technical effect of providing an integrated embedded space to display the stereoscopic image.

### CROSS-REFERENCE STATEMENT

The present application is based on, and claims priority from, TAIWAN Patent Application Serial Number 114114032, filed 2025 Apr. 14, the disclosure of which is hereby incorporated by reference herein in its entirety.

### BACKGROUND OF THE INVENTION

### 1. Field of the Invention

The present invention relates to a stereoscopic display device, and more particularly to a handheld box-type stereoscopic display device with an integrated embedded space.

### 2. Description of the Related Art

The technology used for the stereoscopic image has matured over the years with market demand. Generally, in some fields (such as games, movies or multimedia) the images with a stereoscopic effect (i.e., three-dimensional image) is visually attractive compared to traditional flat images.

However, the cost of developing such stereoscopic visual entertainment applications is relatively high, and displaying the stereoscopic image requires a large amount of processing power and other computing resources. In addition, the stereoscopic images may overstimulate the vision of some viewers and cause slight discomfort, some viewers who are not accustomed to viewing images with three-dimensional effects may even feel dizzy. Therefore, based on cost-effectiveness considerations, most mainstream applications are still designed to be displayed in a flat manner.

Therefore, a handheld box-type stereoscopic display device that significantly reduces the dynamic effect of the displayed stereoscopic image can help and enhance the freshness and user experience of viewers.

In summary, what is needed is to develop an improved solution to solve the problem that displaying the stereoscopic image is costly and requires users to have adaptability.

### SUMMARY OF THE INVENTION

An objective of the present invention is to disclose a handheld box-type stereoscopic display device with integrated embedded space, to solve the problem that displaying the stereoscopic image is costly and requires users to have adaptability.

To achieve the objective, the present invention discloses a handheld box-type stereoscopic display device with integrated embedded space, and the device includes an outer shell, a device circuit board, an embedded glass trough, a stereoscopic image displayer, and a front cover.

The device circuit board is disposed on a bottom of the outer shell. The embedded glass trough is integrally formed with rounded edges and corners, wherein an outer surface of the embedded glass trough is opaque, the embedded glass trough has a connection slot disposed on a bottom thereof, and the embedded glass trough is embedded and fixed in the outer shell. The stereoscopic image displayer is embedded and fixed in the embedded glass trough and electrically connected to the device circuit board through the connection slot, and configured to display a stereoscopic image. The front cover is embedded and fixed with a transparent touch panel, wherein the front cover covers the outer shell to form a seal, and the transparent touch panel covers the embedded glass trough to form a stereoscopic image displayer space, which is sealed, to display the stereoscopic image, and the transparent touch panel is electrically connected to the device circuit board to realize a touch tapping and sliding operation.

In an embodiment, the stereoscopic image displayer includes a display panel and at least one of a parallax barrier layer, a lenticular lens array layer, and a light field display layer.

In an embodiment, the device circuit board includes a processor, an image processor, at least one memory module, and at least two connector port.

In an embodiment, the device circuit board is electrically connected to at least one battery embedded in the outer shell to obtain power supply.

In an embodiment, the handheld box-type stereoscopic display device obtains the stereoscopic image through an external storage medium.

In an embodiment, the external storage medium includes a SD memory card, a USB device, and a cloud server.

In an embodiment of the handheld box-type stereoscopic display device with integrated embedded space, the handheld box-type stereoscopic display device includes a radio-frequency identification (RFID) reader disposed at a top of the outer shell to read the stereoscopic image stored in the radio frequency identification tag.

In an embodiment, the handheld box-type stereoscopic display device includes a speaker device to play background music and sound effects.

In an embodiment, the handheld box-type stereoscopic display device includes at least one operation button and at least one front camera disposed on the front cover, the at least one operation button is configured to select the stereoscopic image displayed by the stereoscopic image displayer through a touch operation of the transparent touch panel, the device circuit board integrates at least one image from the at least one front camera as the stereoscopic image and the stereoscopic image displayer displays the stereoscopic image.

In an embodiment, the handheld box-type stereoscopic display device cooperates with the at least one front camera to immediately determine and calculate a viewing angle of viewing the stereoscopic image and dynamically correct a touch position by using a parallax correction technology to calculate a parallax change based on the viewing angle.

According to the above-mentioned content of the present invention, the handheld box-type stereoscopic display device of the present invention can include an integrally formed embedded glass trough with rounded edges and corners, the outer surface of the embedded glass trough is opaque, the embedded glass trough is embedded and fixed in the outer shell, the front cover is embedded and fixed with the transparent touch panel, the front cover covers and is fixed in the outer shell to form a seal, and the transparent touch panel covers the embedded glass trough to form a sealed stereoscopic image displayer space for displaying the stereoscopic image, and the transparent touch panel realizes the touch tapping and sliding operation.

According to the above-mentioned solution, the present invention can achieve the technical effect of providing an integrated embedded space to display the stereoscopic image.

### BRIEF DESCRIPTION OF THE DRAWINGS

The structure, operating principle and effects of the present invention will be described in detail by way of various embodiments which are illustrated in the accompanying drawings.

FIG. 1 is a perspective exploded view of a handheld box-type stereoscopic display device with an integrated embedded space, according to the present disclosure.

FIG. 2 is a block diagram of a device circuit board of a handheld box-type stereoscopic display device with an integrated embedded space, according to the present invention.

FIG. 3 is a stereoscopic assembled view of a handheld box-type stereoscopic display device with an integrated embedded space, according to the present invention.

FIG. 4 is a schematic view of a stereoscopic image of a handheld box-type stereoscopic display device with an integrated embedded space, according to the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions, and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include,” and variations such as “comprises,” “comprising,” “includes,” or “including,” will be acknowledged to imply the inclusion of stated elements but not the exclusion of any other elements.

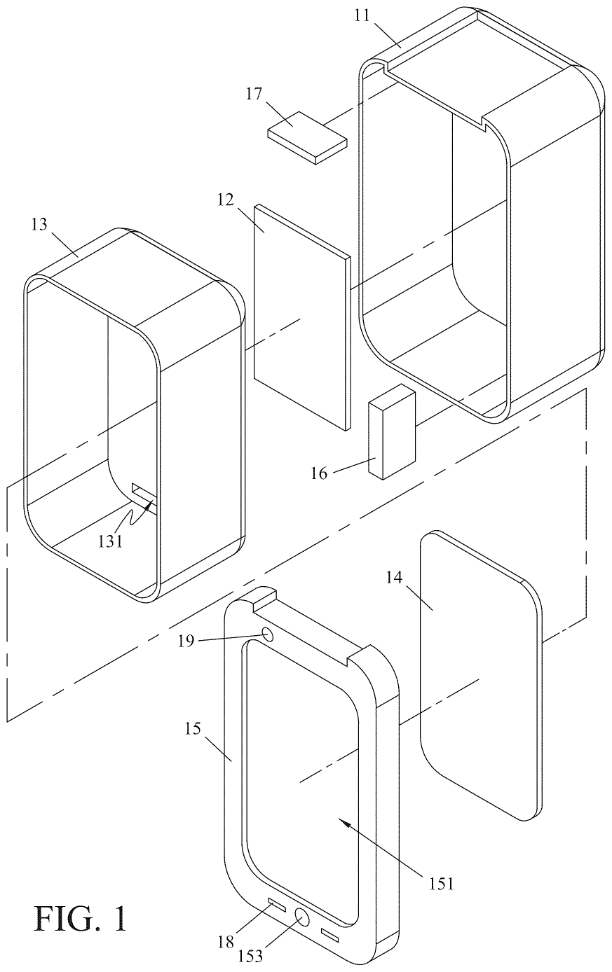

The following first explains the handheld box-type stereoscopic display device with integrated embedded space disclosed in the present invention. Please refer to FIG. 1. FIG. 1 is a perspective exploded view of a handheld box-type stereoscopic display device with an integrated embedded space, according to the present disclosure.

As shown in FIG. 1, the handheld box-type stereoscopic display device 10 with integrated embedded space includes an outer shell 11, a device circuit board 12, an embedded glass trough 13, a stereoscopic image displayer 14, and a front cover 15.

As shown in FIG. 1, the outer shell 11 of the handheld box-type stereoscopic display device 10 is illustrated as a rectangular body; in an embodiment, the outer shell 11 can be in different geometric three-dimensional shape, such as cylinders, prisms, or truncated cones; the outer shell 11 can be made of metal, polymer, or special materials, the metal materials mentioned above include steel, aluminum alloy, or titanium alloy; the polymer materials mentioned above can include ABS, PC, or PC/ABS; the special materials mentioned above can include carbon fiber, or high glass fiber; however, these examples are merely for exemplary illustration, and the scope of application of the present invention is not limited thereto.

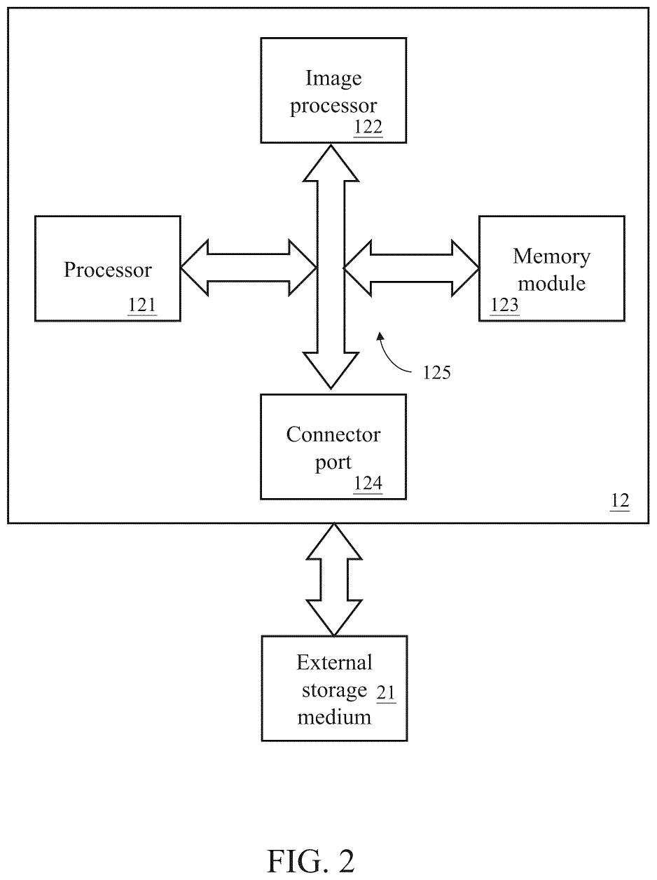

Please refer to FIG. 2. FIG. 2 is a block diagram of a device circuit board of a handheld box-type stereoscopic display device with integrated embedded space, according to the present invention. The device circuit board 12 is fixedly disposed at a bottom of the outer shell 11 through a screw fixing manner, or a buckle fixing manner. The device circuit board 12 includes, but not limited to, a processor 121, an image processor 122, at least one memory module 123, and at least two connector ports 124, the device circuit board 12 is electrically connected to at least one battery 16 embedded in the outer shell 11 to obtain power supply, the device circuit board 12 loads and runs an operating system, to make the handheld box-type stereoscopic display device 10 run with the operating system.

The processor 121, the image processor 122, the at least one memory module 123, and the at least two connector ports 124 are electrically connected to each other through a bus 125. The bus 125 mentioned in the present invention can include at least one type of bus, for example, the bus can include at least one of a data bus, an address bus, a control bus, an expansion bus, and a local bus. The bus of a computation device can include, but not limited to, a parallel bus such as an industry standard architecture (ISA) bus, a peripheral component interconnect (PCI) bus, a video electronics standards association (VESA) local bus, or a serial bus such as a USB, or a PCI express (PCI-E/PCIe) bus.

The processor 121 and the image processor 122 are coupled with the bus 125, respectively. Each of the processor 121 and the image processor 122 includes a register group or a register space. The register group or the register space can be completely set on the processing chip or can be all or partially set outside the processing chip and is coupled to the processing chip through dedicated electrical connection and/or the bus 125. If the device circuit board 12 has the processors 121 and the image processors 122, the processors 121 or the image processors 122 can be all the same or similar, and coupled and communicated with each other through the bus 125. The processing module can interpret a computer instruction or a series of computer instructions to perform specific operations or operations, such as mathematical operations, logical operations, data comparison, data copy/moving, so as to drive other hardware component, execute the operating system, or execute various programs, modules, and/or components.

The processor 121 and the image processor 122 are coupled with a chipset or electrically connected to chipset through the bus 125. The chipset includes one or more integrated circuits (IC) including a memory controller and a peripheral input/output (I/O) controller, that is, the memory controller and the peripheral input/output controller can be implemented by one integrated circuit, or implemented by two or more integrated circuits. Chipsets usually provide I/O and memory management functions, and multiple general-purpose and/or dedicated-purpose registers, timers. The above-mentioned general-purpose and/or dedicated-purpose registers and timers can be coupled to or electrically connected to one or more processor to the chipset for being accessed or used.

The processor 121 and the image processor 122 can also access the data stored in the memory module 123 and mass storage area installed on the device circuit board 12 through the memory controller. The above-mentioned memory module 123 include any type of volatile memory and/or non-volatile memory (NVRAM), such as Static Random Access Memory (SRAM), Dynamic Random Access Memory (DRAM), Read-Only Memory (ROM), or Flash memory. The above-mentioned mass storage area can include any type of storage device or storage medium, such as hard disk drives, optical discs, flash drives, memory cards, and solid state disks (SSD), or any other storage device. In other words, the memory controller can access data stored in static random access memory, dynamic random access memory, flash memory, hard disk drives, and solid state drives.

The processor 121 can also connect and communicate with peripheral devices and interfaces including peripheral output devices, peripheral input devices, communication interfaces, or data/signal receivers through the peripheral I/O controller and the bus 125. The peripheral input device can be any type of input device, such as a keyboard, mouse, trackball, touchpad, or joystick. The peripheral output device can be any type of output device, such as a display, or a printer; the peripheral input device and the peripheral output device can also be the same device such as a touch screen. The communication interface can include a wireless communication interface and/or a wired communication interface. The wireless communication interface can include the interface capable of supporting wireless local area networks (such as Wi-Fi, Zigbee, etc.), Bluetooth, infrared, and near-field communication (NFC), 3G/4G/5G and other mobile communication network (cellular network) or other wireless data transmission protocol; the wired communication interface can be an Ethernet device, an asynchronous transfer mode (ATM) devices, a DSL modem, a cable modem. The processor 121 can periodically poll various peripheral devices and interfaces, so that the computing apparatus can input and output data through various peripheral devices and interfaces, and can also communicate with another computing apparatus having the above-mentioned hardware components.

Please refer to FIG. 1. The embedded glass trough 13 is directly embedded and fixed in the outer shell 11, the embedded glass trough 13 can also be embedded and fixed in the outer shell 11 with the front cover 15, but these examples are merely for exemplary illustration, and the scope of application of the present invention is not limited thereto. The embedded glass trough 13 is made of glass material and integrally formed with rounded edges and corners, the outer surface of the embedded glass trough 13 is covered with a light-blocking film to make the outer surface of the embedded glass trough 13 opaque; however, these examples are merely for exemplary illustration, and the scope of application of the present invention is not limited thereto. The embedded glass trough 13 has a connection slot 131 formed on the bottom thereof, the connection slot 131 can make the stereoscopic image displayer 14 embedded in the embedded glass trough 13 electrically connect to the connector port 124 of the device circuit board 12 through flexible flat cables, and the device circuit board 12 cooperates with the stereoscopic image displayer 14 to display the stereoscopic image of the handheld box-type stereoscopic display device 10.

The embedded glass trough 13 mentioned above has the following ability to enhance the avoidance of excessive external light entering the subsequent mentioned stereoscopic image displayer space, and thereby affecting the contrast of the stereoscopic image displayed in the stereoscopic image displayer space to enhance the sharpness of the stereoscopic image, making the light in the stereoscopic image displayer space controllable to effectively reduce environmental light interference and improve the stability and clarity of the stereoscopic image displayed in the stereoscopic image displayer space.

In one embodiment, an inner surface of the embedded glass trough 13 further includes a partially reflective area and a partially transmissive area, so that the inner surface of the embedded glass trough 13 can form a “semi-lens” effect, which can enhance the floating feeling of the stereoscopic image displayed in the stereoscopic image displayer space. The inner surface of the embedded glass trough 13 can also be coated with augmented reality (AR) coating or polarized beam-splitting coating (these examples are merely for exemplary illustration, and the scope of application of the present invention is not limited thereto), thereby reducing unnecessary light reflection in the stereoscopic image displayer space to ensure the stability and clarity of the stereoscopic image displayed in the stereoscopic image displayer space and enhance stereo perception of the stereoscopic image displayed in the stereoscopic image displayer space.

In another embodiment, the embedded glass trough 13 can also be made into a waveguide structure to evenly distribute the light in the stereoscopic image displayer space and reduce parallax distortion, thereby allowing the stereoscopic image to be viewed consistently from different angles; furthermore, the handheld box-type stereoscopic display device 10 can further provide a multi-region optical system, a dynamic parallax adjustment system, and/or a dynamic viewing angle adjustment system to allow multiple viewers to simultaneously view the stereoscopic image, thereby making the stereoscopic image adapt to different viewing positions; the handheld box-type stereoscopic display device 10 can also use an eye-tracking technology to immediately adjust the viewing angle of the stereoscopic image output by the stereoscopic image displayer 14, thereby making the stereoscopic image viewed from different positions accurate; however, these examples are merely for exemplary illustration, and the scope of application of the present invention is not limited thereto.

The stereoscopic image displayer 14 includes a display panel and at least one of a parallax barrier layer, a lenticular lens array layer, and a light field display layer. The display panel of the stereoscopic image displayer 14 is generally an LCD panel or OLED panel, and the display panel can simultaneously display multi-viewing-angle images. In an embodiment, the stereoscopic image displayer 14 can have gating (mask) of the parallax barrier layer overlayed in front of the display panel to make the left and right eyes see different images. In an embodiment, the stereoscopic image displayer 14 can have a lenticular lens array layer overlayed in front of the display panel to achieve left and right eye parallax by blocking part of the pixels. In an embodiment, the stereoscopic image displayer 14 can have the light field display layer overlayed in front of the display panel using multi-layer display panel or holographic technology, thereby producing more natural multi-viewing angle images. However, these examples are merely for exemplary illustration, and the scope of application of the present invention is not limited thereto.

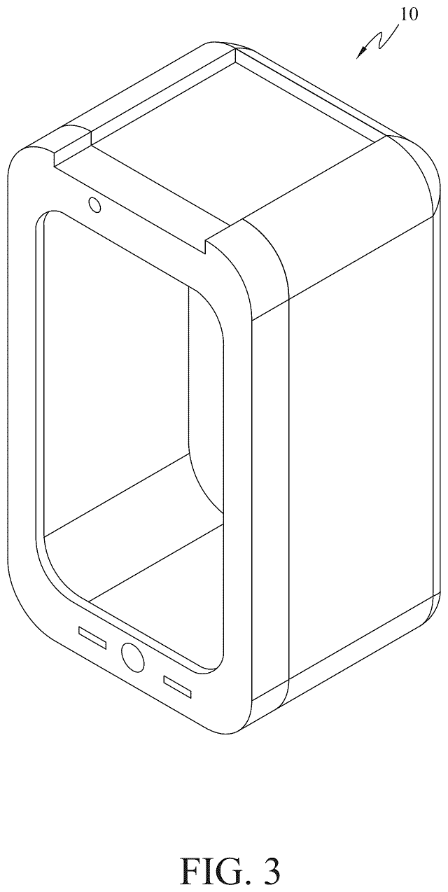

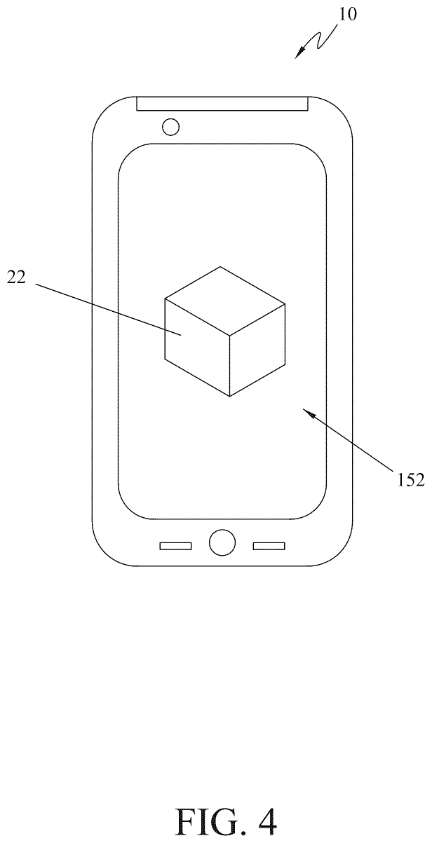

The front cover 15 embedded with the transparent touch panel 151 can cover the outer shell 11, and the front cover 15 and the outer shell 11 are fixedly sealed by using a screw fixing manner or a buckle fixing manner. The transparent touch panel 151 also cover the embedded glass trough 13 to form a sealed stereoscopic image displayer space 152. The assembled handheld box-type stereoscopic display device 10 is shown in FIG. 3. FIG. 3 is a stereoscopic assembled view of a handheld box-type stereoscopic display device with integrated embedded space, according to the present invention. The stereoscopic image displayer 14 displays the stereoscopic image 22 in the stereoscopic image displayer space 152. Please refer to FIG. 4. FIG. 4 shows a schematic view of the stereoscopic image 22 displayed in the stereoscopic image displayer space 152. FIG. 4 is a schematic view of a stereoscopic image of a handheld box-type stereoscopic display device with integrated embedded space, according to the present invention.

It is worth noting that the transparent touch panel 151 is electrically connected to the connector port 124 of the device circuit board 12 through a flexible flat cable, to realize touch tapping and sliding operations, so that the device circuit board 12 can cooperate with the transparent touch panel 151 to achieve the touch tapping and sliding operations. In an embodiment, the transparent touch panel 151 mentioned above is made by capacitive touch technology, optical touch technology, infrared touch technology, ultrasonic touch technology; among these technologies, the projected capacitive (P-Cap) touch technology in capacitive touch technology is the best implementation technology. However, these examples are merely for exemplary illustration, and the scope of application of the present invention is not limited thereto.

In practical applications, the stereoscopic image 22 displayed in the stereoscopic image displayer space 152 by the stereoscopic image displayer 14 can be viewed from different viewing angles. When the stereoscopic image 22 is viewed from a front viewing angle, a left-tilted viewing angle or a right-tilted viewing angle, the position of the touch component (the icon of the application) projected on the stereoscopic image 22 is different in different viewing angle, and this causes that a touch operation on the component can be correctly performed from the front viewing angle, but the touch operation on the component cannot be correctly performed from the left-tilted viewing angle or right-tilted viewing angle.

Therefore, it is necessary to further use at least one front camera 19 (mentioned later) with a head tracking technology to immediately calculate the viewing angle of viewing the stereoscopic image 22 and dynamically adjust a mapping relationship of touch points based on the calculated viewing angle. The head tracking technology compensates a touch offset caused by the change in the viewing angle, to ensure that the touch position still accurately corresponds to the touch component of the stereoscopic image 22 under different viewing angles. At least one front camera 19, an infrared sensor, or an optical tracking system is used to determine the position of the viewer's eyes, a parallax correction technology is used to calculate a parallax change based on the viewer's viewing angle, thereby dynamically correcting the touch position mapped to the correct touch component of the stereoscopic image 22.

In one embodiment, the parallax correction technology mentioned above is based on Geometric Perspective Transformation, that is, homography transformation is used to correct the touch point mapping relationship under different viewing angles, the parallax of the stereoscopic image under different viewing angles can be regarded as the transformation of plane projection, Homography Matrix (HHH) can be used for correction, the touch point P_{orig} of the original viewing angle (i.e., front viewing angle), and the mapping point P_{new} of the offset viewing angle (i.e., left-tilted viewing angle or right-tilted viewing angle) can be transformed based on the formula: P_{new}=H·P_{orig}, where H is the homography matrix calculated by the four-point correspondence, which is applied to the touch point transformation when the viewing angle changes. However, these examples are merely for exemplary illustration, and the scope of application of the present invention is not limited thereto.

In another embodiment, the parallax correction technology mentioned above can also be realized based on eye tracking parallax compensation. An eye tracking technology is used to immediately calculate a parallax relationship between the viewing angle and the stereoscopic image 22, thereby dynamically correcting a touch mapping relationship. After the position of the viewer's eyes is determined, the viewing angle θ is calculated by using the parallax model, the real mapping point of the touch position P_{touch} in three-dimensional space is estimated based on the formula: P_{corrected}=P_{touch}+f(θ), where P_{corrected} is the corrected position, f(θ) is the viewing angle offset function. The viewing angle offset function can be established through empirical calibration methods, which predict the touch offset under different viewing angles to establish the viewing angle offset function through testing the offset amount under different viewing angles or using machine learning models (such as CNN, or RNN). However, these examples are merely for exemplary illustration, and the scope of application of the present invention is not limited thereto.

In another embodiment, the parallax correction technology mentioned above can also be based on AI-based viewpoint correction, which uses deep learning models to predict the touch offset under different viewing angles and dynamically correct the touch position. To achieve the AI-based viewpoint correction, first, the touch point mapping data under different viewing angles are collected, for example, the viewing angles and the corresponding touch point are recorded by viewing angle tracking equipment; the offset amount when clicking the touch component of the stereoscopic image 22 under different viewing angles are recorded, and convolutional neural networks (CNN) or regression models are used to learn the relationship between the viewing angle changes and touch offsets, so that the touch point correction value can be predicted in real-time through the trained model. However, these examples are merely for exemplary illustration, and the scope of application of the present invention is not limited thereto.

The outer shell 11 or the front cover 15 further has an exposed slot, so that the connector port 124 of the device circuit board 12 can be exposed out of the outer shell 11 or the front cover 15 and connected with the external storage medium 21. After obtaining the stereoscopic image 22 through the external storage medium 21, the stereoscopic image displayer 14 displays the stereoscopic image 22 in the stereoscopic image displayer space 152. In an embodiment, the external storage medium 21 can be, for example, a SD memory card, a USB device, or a cloud server, but these examples are merely for exemplary illustration, and the scope of application of the present invention is not limited thereto.

Specifically, when the external storage medium 21 is a SD memory card, the connector port 124 of the device circuit board 12 can be a SD memory card reading port; when the SD memory card is inserted into the SD memory card reading port and the device circuit board 12 reads the stereoscopic image 22 stored in the SD memory card, the stereoscopic image displayer 14 can display the stereoscopic image 22 in the stereoscopic image displayer space 152. When the external storage medium 21 is a USB device, the connector port 124 of the device circuit board 12 can be a USB connector port, when the USB device is inserted into the USB connector port and the device circuit board 12 reads the stereoscopic image 22 stored in the USB device, the stereoscopic image displayer 14 can display the stereoscopic image 22 in the stereoscopic image displayer space 152. When the external storage medium 21 is a cloud server, the connector port 124 of the device circuit board 12 can be a RJ45 network connector port or a wireless network connector port. When the handheld box-type stereoscopic display device 10 is connected to the cloud server through the internet or wireless network and the device circuit board 12 obtains the stereoscopic image 22 stored in the cloud server, the stereoscopic image displayer 14 can display the stereoscopic image 22 in the stereoscopic image displayer space 152. However, these examples are merely for exemplary illustration, and the scope of application of the present invention is not limited thereto.

In an embodiment, a radio-frequency identification (RFID) reader 17 can be disposed on the top of the outer shell 11 and electrically connected to the device circuit board 12 through a flexible flat cable. When the RFID reader 17 reads the stereoscopic image stored in the RFID tag, the stereoscopic image displayer 14 displays the stereoscopic image 22 in the stereoscopic image displayer space 152. In an embodiment, when the device circuit board 12 reads the stereoscopic image 22 stored in the radio frequency identification tag through the RFID reader 17, the stereoscopic image displayer 14 displays the stereoscopic image 22 in the stereoscopic image displayer space 152.

The handheld box-type stereoscopic display device 10 includes a speaker device 18 disposed in the outer shell 11 or the front cover 15 and electrically connected to the device circuit board 12 through a flexible flat cable to play background music and sound effects. In an embodiment, the handheld box-type stereoscopic display device 10 can include at least one button 153 disposed in the front cover 15 and electrically connected to the device circuit board 12 through a flexible flat cable. The button 153 can cooperate with the touch operation of the transparent touch panel 151 to select the stereoscopic image 22 displayed by the stereoscopic image displayer 14.

In an embodiment, the handheld box-type stereoscopic display device 10 includes at least one front camera 19 disposed in the front cover 15 and electrically connected to the device circuit board 12 through a flexible flat cable, and the device circuit board 12 can integrate at least one image from the at least one front camera 19 to obtain the real-time stereoscopic image 22, and the stereoscopic image displayer 14 immediately displays the stereoscopic image 22 in the stereoscopic image displayer space 152.

In summary, the handheld box-type stereoscopic display device of the present invention can include an integrally formed embedded glass trough with rounded edges and corners, the outer surface of the embedded glass trough is opaque, the embedded glass trough is embedded and fixed in the outer shell, the front cover is embedded and fixed with the transparent touch panel, the front cover covers and is fixed in the outer shell to form a seal, and the transparent touch panel covers the embedded glass trough to form a sealed stereoscopic image displayer space for displaying the stereoscopic image, and the transparent touch panel realizes the touch tapping and sliding operation.

According to the above-mentioned solution, the present invention can solve the conventional problem that displaying the stereoscopic image is costly and requires users to have adaptability, to achieve the technical effect of providing an integrated embedded space to display the stereoscopic image.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A handheld box-type stereoscopic display device with an integrated embedded space, comprising:
an outer shell;
a device circuit board, disposed on a bottom of the outer shell;
an embedded glass trough, integrally formed with rounded edges and corners, wherein an outer surface of the embedded glass trough is opaque, the embedded glass trough has a connection slot disposed on a bottom thereof, and the embedded glass trough is embedded and fixed in the outer shell;
a stereoscopic image displayer, embedded and fixed in the embedded glass trough and electrically connected to the device circuit board through the connection slot, and configured to display a stereoscopic image; and
a front cover, embedded and fixed with a transparent touch panel, wherein the front cover covers the outer shell to form a seal, and the transparent touch panel covers the embedded glass trough to form a stereoscopic image displayer space, which is sealed, to display the stereoscopic image, and the transparent touch panel is electrically connected to the device circuit board to realize a touch tapping and sliding operation.

2. The handheld box-type stereoscopic display device with integrated embedded space according to claim 1, wherein the stereoscopic image displayer comprises a display panel and at least one of a parallax barrier layer, a lenticular lens array layer, and a light field display layer.

3. The handheld box-type stereoscopic display device with integrated embedded space according to claim 1, wherein the device circuit board comprises a processor, an image processor, at least one memory module, and at least two connector port.

4. The handheld box-type stereoscopic display device with integrated embedded space according to claim 3, wherein the device circuit board is electrically connected to at least one battery embedded in the outer shell to obtain power supply.

5. The handheld box-type stereoscopic display device with integrated embedded space according to claim 1, wherein the handheld box-type stereoscopic display device obtains the stereoscopic image through an external storage medium.

6. The handheld box-type stereoscopic display device with integrated embedded space according to claim 5, wherein the external storage medium comprises a SD memory card, a USB device, and a cloud server.

7. The handheld box-type stereoscopic display device with integrated embedded space according to claim 1, wherein the handheld box-type stereoscopic display device comprises a radio-frequency identification (RFID) reader disposed at a top of the outer shell to read the stereoscopic image stored in the radio frequency identification tag.

8. The handheld box-type stereoscopic display device with integrated embedded space according to claim 1, wherein the handheld box-type stereoscopic display device comprises a speaker device to play background music and sound effects.

9. The handheld box-type stereoscopic display device with integrated embedded space according to claim 1, further comprising at least one operation button and at least one front camera disposed on the front cover, the at least one operation button is configured to select the stereoscopic image displayed by the stereoscopic image displayer through a touch operation of the transparent touch panel, the device circuit board integrates at least one image from the at least one front camera as the stereoscopic image and the stereoscopic image displayer displays the stereoscopic image.

10. The handheld box-type stereoscopic display device with integrated embedded space according to claim 9, wherein the handheld box-type stereoscopic display device cooperates with the at least one front camera to immediately determine and calculate a viewing angle of viewing the stereoscopic image and dynamically correct a touch position by using a parallax correction technology to calculate a parallax change based on the viewing angle.
